(19) United States
(12) Patent Application Publication
(10) Pub. No.: US 2008/0012461 A1
(43) Pub. Date: Jan. 17, 2008

(54) Carbon nanotube cold cathode

(75) Inventors: Zvi Yaniv, Austin, TX (US); Dongsheng Mao, Austin, TX (US)

Correspondence Address: FISH & RICHARDSON P.C., P.O BOX 1022, Minneapolis, MN, 55440-1022, US

(73) Assignee: Nano-Proprietary, Inc., Austin, TX (US)

(21) Appl. No.: 11/270,274

(22) Filed: Nov. 9, 2005

Related U.S. Application Data
(60) Provisional application No. 60/626,273, filed on Nov. 9, 2004.

(51) Int. Cl. H01J 1/02

(52) U.S. Cl. 313/309

(57) ABSTRACT

A carbon nanotube layer for a field emission cathode where individual carbon nanotubes or small groups of carbon nanotubes that stick out from the surface more than the rest of the layer are avoided. Electron fields will concentrate on these sharp points, creating an enhanced image on the phosphor, resulting in a more luminous spot than the surroundings. Activation processes further free such carbon nanotubes or groups of carbon nanotubes sticking out from the surface, exasperating the problem.

This application claims priority to U.S. Provisional Patent Application Ser. No. 60/626,273.

### TECHNICAL FIELD

The present invention relates in general to cold cathodes, and in particular to cold cathodes utilizing carbon nanotubes.

### BACKGROUND INFORMATION

A number of companies and institutions are researching carbon nanotubes (CNTs) because of their excellent physical, chemical, electrical, and mechanical properties (see Walt A. de Heer, “Nanotubes and the Pursuit of Applications,” MRS Bulletin 29(4), 281-285 (2004)). They can be used as excellent cold electron sources for many applications such as displays, microwave sources, x-ray tubes, etc. because of their high aspect ratio and chemical inertness for very stable and low voltage operation with long lifetime (see Zvi Yaniv, “The Status of the Carbon Electron Emitting Films for Display and Microelectronic Applications,” The International Display Manufacturing Conference, Jan. 29-31, 2002, Seoul, Korea). Aligned carbon nanotubes have been demonstrated to have excellent field emission properties, which can be made by chemical vapor deposition (CVD) on catalyst-supported substrate at over 500° C. (see Z. F. Ren, Z. P. Huang, J. W. Xu et al., “Synthesis of Large Arrays of Well-Aligned Carbon Nanotube On Glass,” Science 282, 1105-1107 (1998)). But the CVD process is not a good way to grow CNTs over large areas because it is very difficult to achieve high uniformity required for display applications. CVD growth of CNTs also requires a high process temperature (over 500° C.), eliminating the use of low-cost substrates such as soda-lime glass.

An easier way is to collect the CNT powders and deposit them uniformly onto a selected area of the substrate. CNTs can be printed through a mesh screen if mixed with a binder, epoxy, etc. (see D. S. Chung, W. B. Choi, J. H. Kang et al., “Field Emission from 4.5 in. Single-Walled and Multiwalled Carbon Nanotube Films,” J. Vac. Sci. Technol. B18(2), 1054-1058 (2000)). They can be sprayed onto the substrate if they are mixed with a solvent such as IPA, acetone, or water (see D. S. Mao, R. L. Fink, G. Monty et al., “New CNT Composites for Feds That Do Not Require Activation,” to be presented and included in the proceedings of the Ninth International Display Workshops, Hiroshima, Japan, p. 1415, Dec. 4-6, 2002). Other ways, such as brushing, dispersing, dispensing, screen-printing, dipping, immersing, spin-coating, electrophoretic deposition, ink jet printing, and dry coating processes can also be utilized to deposit a layer of CNTs onto a substrate.

But a significant problem is that the carbon nanotube powders possess very strong van der Waals forces, and as a result, for single wall carbon nanotubes (SWNTs), they form ropes that can include a number of carbon nanotubes sticking together along the width and length, generally forming ropes with diameters up to 30 nm and lengths generally in the range of 2 to 20 micrometers or more. Furthermore, the ropes can form bundles (many ropes clumped together). For multiwall carbon nanotubes (MWNTs), diameters can be varying from several nanometers to hundreds of nanometers and lengths can be from several microns to 1 mm range.

After the CNTs are deposited onto the substrate, an activation process is employed to vertically align the CNTs in order to improve the field emission properties of the carbon nanotubes (see Yu-Yang Chang, Jyh-Rong Sheu, Cheng-Chung Lee, “Method of Improving Field Emission Efficiency for Fabricating Carbon Nanotube Field Emitters,” U.S. Pat. No. 6,436,221 B1). When a negative voltage is applied to the CNT cathode, the electric field lines are concentrated near the top of the CNTs, greatly enhancing the strength of the electric field in the vicinity of the top. The enhancement of the field is dependant on the diameter of the nanotube, the length of the nanotube exposed to the field, and the ratio of the diameter to the length. Having clusters of a large range of sizes and having a very broad distribution of diameters and lengths of CNTs and CNT ropes and bundles may greatly affect the field emission uniformity of the CNT cathodes.

### BRIEF DESCRIPTION OF THE DRAWINGS

For a more complete understanding of the present invention, the advantages thereof, reference is now made to the following descriptions taken in conjunction with the accompanying drawings, in which:

FIG. 1 illustrates length distributions of two different kinds of CNT powders;

FIG. 2 illustrates a schematic diagram of CNT coatings on a substrate;

FIG. 3 illustrates a schematic diagram of a spray process;

FIG. 4 illustrates a schematic diagram of a grinding process;

FIG. 5 illustrates a graph of field emission current versus electric field curves of two samples;

FIG. 6 illustrates field emission digital images of two samples;

FIG. 7 illustrates a digital image of a CNT coating on a substrate;

FIG. 8 illustrates a field emission digital image on a sample; and

FIG. 9 illustrates a digital image of a CNT coating on a substrate.

### DETAILED DESCRIPTION

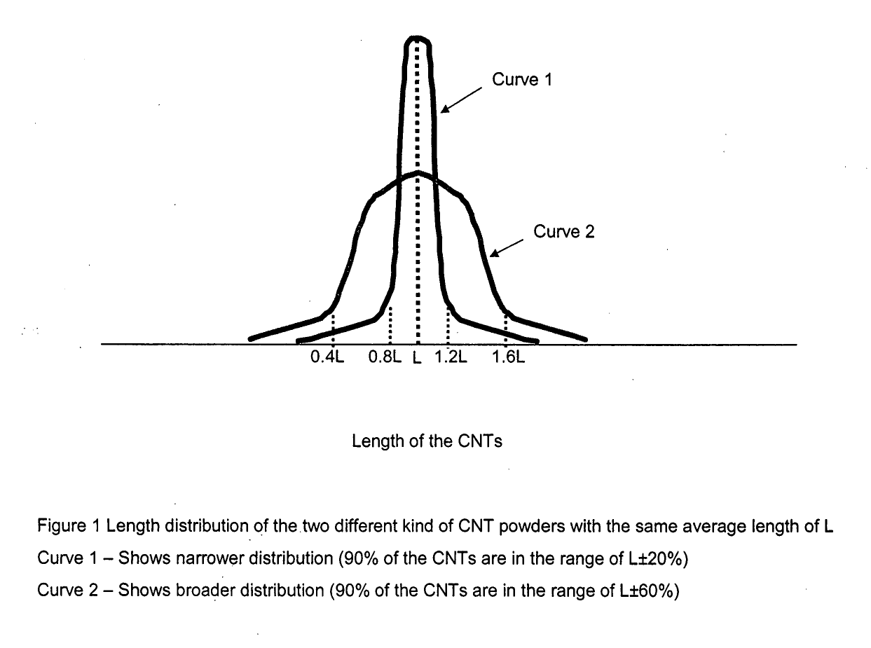

In order to make a CNT cathode with good uniformity, CNT powders should be used in which the nanotubes are of equal length and diameter or having both a length and diameter very closer to each other. The variation of the lengths and diameters should be less than 20% for at least 90% of the total quantity of the CNT powders. For example, for an average length of 10 micron CNT powders, at least 90% of the CNTs should be in a range from 8-12 microns. A variation of 10% in the distribution of both length and diameter for 95% of the nanotubes in the CNT powder is desired—the narrower the distribution, the better for field emission properties. FIG. 1 illustrates a schematic diagram of the length distribution of the two kinds of the CNT coatings with the same average length of L. Curve 1 shows a narrower distribution (90% of the CNTs are in the range of L plus or minus 20%), while Curve 2 shows a broader distribution (90% of the CNTs are in the range of L plus or minus 60%). Curve 1 shows much better quality of the CNT material for more uniform field emission. Secondly, the thickness of the CNT cathode deposited by a certain technique will be very even. The flatness of the surface of the CNT coating will have less than a 20% variation. For example, for an average thickness of a 5 micron CNT coating, the variation will be beyond ±1 micron.

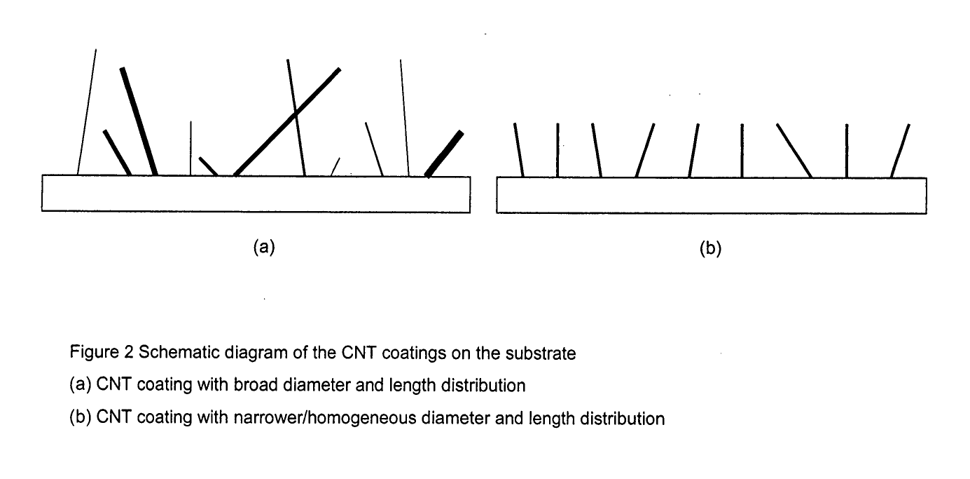

In order to make a good CNT ink, many types of grinding methods are used to open the rope (debundle or deagglomerate the ropes) and shorten the length. There are many types of dispersions, both organic or non-organic, that work very well with carbon nanotubes. To prepare the ink, one needs to disperse the bundles and ropes and break the big clusters in the powders by various ways such as grinding or mechanical agitations. The resulting ink would then be smooth and homogenous, with the right viscosity compatible with the deposition process. FIG. 2 illustrates schematic diagrams of CNT coatings on substrates. FIG. 2(a) illustrates large variations of lengths and diameters of the CNTs in the coating. FIG. 2(b) illustrates an ideal CNT coating for uniform field emission with narrower/homogeneous diameter and length distribution.

Another solution is to shorten the average length of the CNTs with a variation of less than 20% (for example, an average length of less than 5 microns of the CNTs are used). The flatness variation of the CNT coating on the substrate will be narrower if the shorter CNTs are used. Shorter nanotubes may lead to a more uniform coating, both before and after activation of the CNT film as described below.

The section below describes the improvement of the field emission uniformity of the CNTs by dispersing and shortening processes. Also, excellent field emission uniformity is obtained by choosing very close diameters and lengths of CNTs and depositing them smoothly onto the substrate.

Source of Carbon Nanotubes

Both MWNTs and SWNTs may be used.

MWNTs from Nikkiso Co., Japan may be obtained. The average diameter of this material is 15 nm and the lengths range from 5 to 100 microns.

Single wall carbon nanotubes (SWNTs) may be obtained from CarboLex, Inc., Lexington, Ky. These SWNTs were about 1.4 nm in diameter and about 5-10 microns in length. It can be seen that this material has much narrower diameter and length distributions than Nikkiso MWNTs.

Other kinds of CNTs, both purified and unpurified MWNTs, double-wall CNTs (DWNTs), and SWNTs with different diameters and lengths may be used. Those CNTs can be metallic, semiconducting, insulating, or metallized.

CNT Solution Preparation for Depositing a Layer of CNT Coating onto the Substrate by Spray Technique

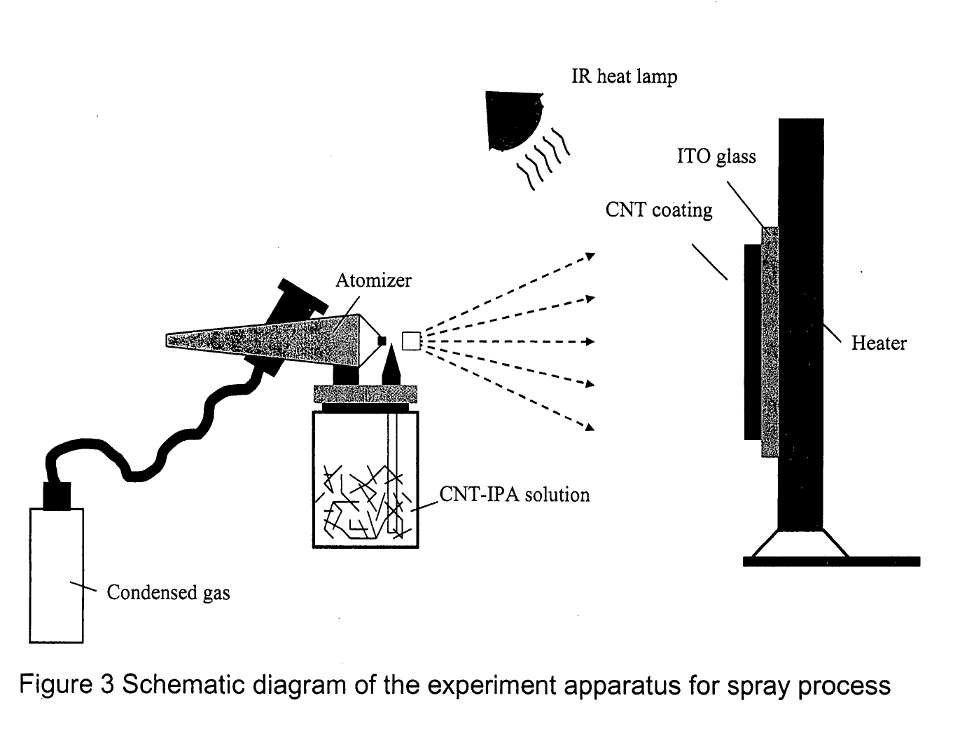

A spray process may be employed to deposit a CNT-IPA solution onto a substrate using airbrush equipment. FIG. 3 illustrates a schematic diagram of an apparatus used for a spray process. The volume of the container to hold the CNT-IPA solution in the airbrush tool may be 30 ml. Other ways, such as brushing, dispersing, screen-printing, dipping, immersing, spin-coating, electrophoretic deposition, ink jet printing, and dry coating processes may also be used to deposit a layer of CNTs onto a substrate.

Nikkiso MWNTs were used. Because there are a lot of big clusters in this raw material, an ultrasonication process was employed to disperse these clusters. 0.05 g of CNTs as well as 25 ml IPA were put in the container. An ultrasonic horn was inserted into the container in order to disperse these big clusters into smaller clusters or individual CNTs. An ultrasonic bath may also work to ultrasonicate the solution. Better uniformity and dispersion of the CNT coating may be obtained by adjusting the concentration of the CNT in IPA solution.

The CNT-IPA solution was sprayed onto ITO/glass with an area of 2×2 cm² using a shadow mask sitting on the surface of the substrate in order to prevent the solution being deposited onto unwanted areas. In order to evaporate the IPA solution quickly, the substrate was heated up to ˜70° C. both on front side and back side. The substrate was sprayed back and forth and up and down several to tens of times until the entire surface was coated with the CNT coating. It was roughly measured that the thickness of the CNT coating was 5-10 micron using optical microscope. The sample was dried in air naturally. But it could also be cure or baked in an oven at a higher temperature. The solution may also be sprayed onto various other substrates such as metal, ceramic, glass, semiconductors and plastics.

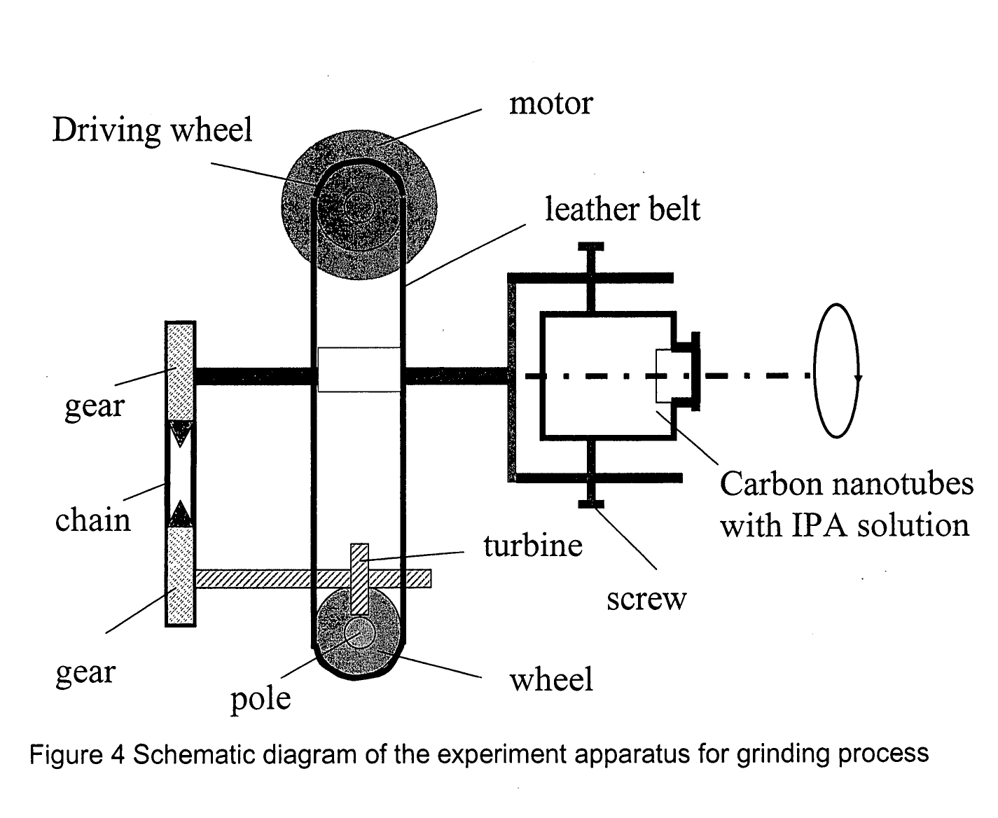

In order to compare the above sample, another sample was prepared by spraying the solution that contained more dispersed and shortened CNTs. 0.05 g of Nikkiso MWNTs as well as 25 ml IPA were placed into a jar. Also, 20-30 stainless steel balls (4 mm in diameter) were added into the solution. It was ground by a ball mill for 240 hours with a rate of 50-60 revolutions per minute. FIG. 4 illustrates a schematic diagram of this ball mill. Grinding using a ball mill is a usual and effective way to disperse clusters and ropes of the CNTs and even shorten them (see “Production of Short Carbon Nanotubes With Open Tips By Ball Milling,” N. Pierard, A. Fonseca, Z. Konya et al., Chemical Physics letters 335, 1-8 (2001)).

After the solution was ground, the stainless steel balls were removed. It was sprayed onto the ITO/glass using the same process as the above sample.

Activation of the CNT Samples

When the CNTs were deposited onto the surface of the substrate, a process was utilized of “activating” the CNT film by applying an adhesive tape material to the film and then pealing the adhesive tape away (see Yang Chang, Jyh-Rong Sheu, Cheng-Chung Lee, Industrial Technology Research Institute, Hsinchu, T W, “Method of Improving Field Emission Efficiency for Fabrication Carbon Nanotube Field Emitters,” U.S. Pat. No. 6,436,221 B1.). After the carbon nanotubes were sprayed on the substrates, an adhesive tape process was used to remove the top layer of the materials on the surface. Clear tape (Catalog number #336, 3M) was used for this process. The tape was adhered on the coating using a laminator. Care may be taken to ensure that there is no air between the tape and the CNT coating. If a bubble exists, the mixture at that area may not be removed or treated as the other areas are. A rubber roll may be used to further press the tape in order to prevent air in the intersection between the tape and the mixture coating. Finally, the tape was removed.

Field Emission Test of the Above Samples

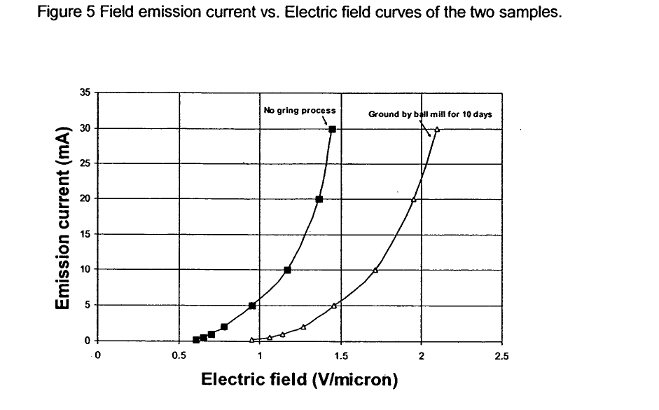

Field emission properties of the both samples were then tested by mounting them with a phosphor screen (ZnS:Cu,Al—green phosphor) in a diode configuration with a gap of about 0.5 mm between the anode and cathode. The test assembly was placed in a vacuum chamber and pumped to 10⁻⁷ Torr. The electrical properties of the cathode were then measured by applying a negative, pulsed voltage (AC) to the cathode and holding the anode at ground potential and measuring the current at the anode. A DC potential may also be used for the testing. A graph of the emission current vs. electric field for the samples is shown in FIG. 5. It can be seen that the sample made with a grinding process by a ball mill has a lower electric field at the same emission current.

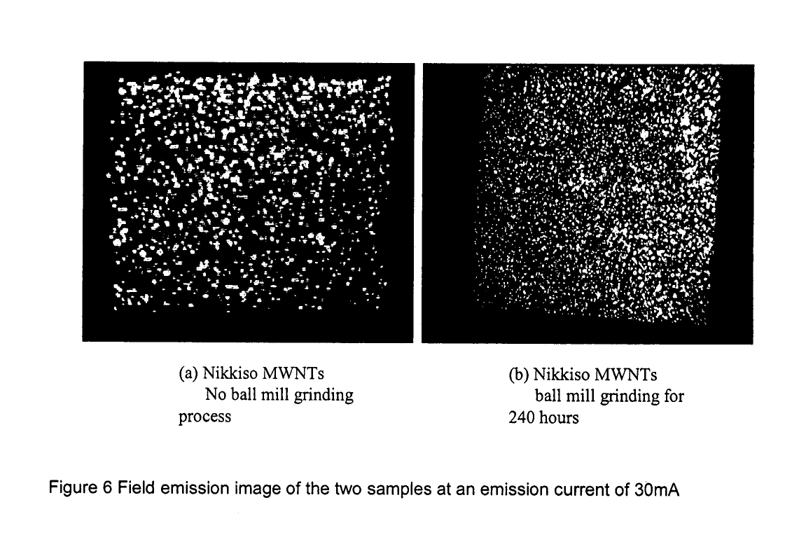

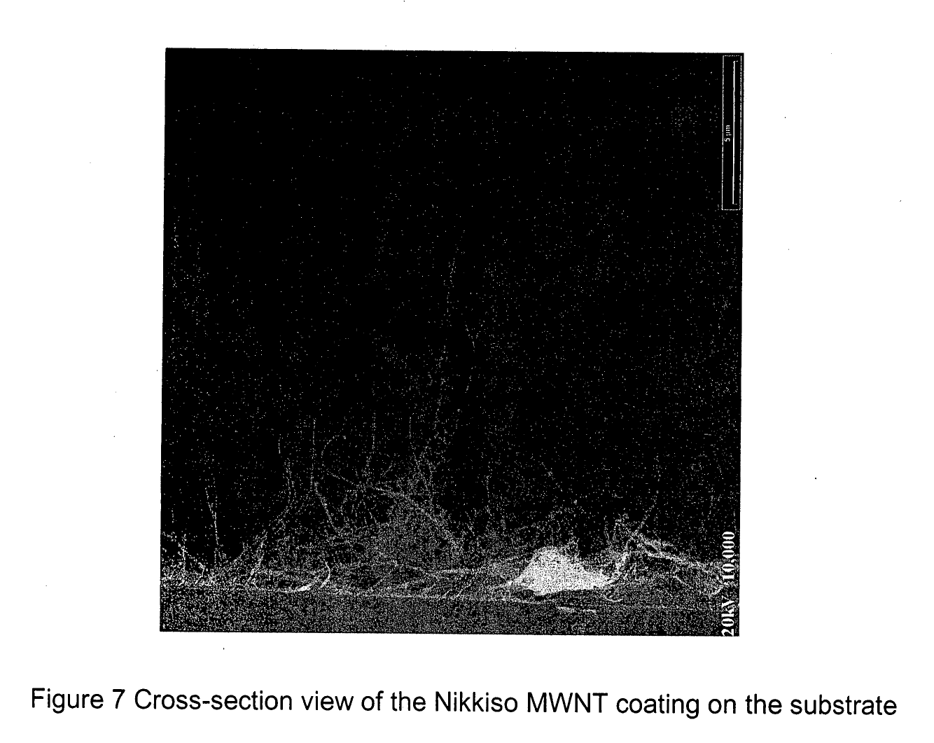

FIG. 6 shows the field emission images of the samples at an emission current of 30 mA. However, the sample made with the CNT material that was ground by a ball mill has much better emission uniformity. Its emission site density is much higher than the other sample. The cross-section SEM image of the sample made with CNT that did not go through a grinding process by a ball mill was obtained. It showed that the coating was very non-uniform (See FIG. 7). One can see both long (>20 micron) and short (<2 micron) CNTs with different diameters. Also the ropes of the CNTs can be seen. Compared with the short CNTs, the other vertically aligned long CNTs seen in the image will have much high geometric field enhancement factor, thus these CNTs will field emit before the features with lower geometric field enhancement factor. That is why the turn on field of this sample was lower—there are many of these features with large enhancement factors. Such a rough surface of the CNT coating will also greatly affect the field emission uniformity of the field emission, which will degrade the quality of the display image. However, if the CNTs are more dispersed and the length distribution are more narrowed, it will have a more uniform field emission.

Preparation of the Sample Using CarboLex SWNTs

As was mentioned above, the CarboLex SWNTs had a much narrower diameter and length distributions than the Nikkiso MWNTs. The same quantity of SWNTs and IPA was used to ground the solution for 240 hours by the ball mill. The CNT coating on ITO/glass was made by the same spray process.

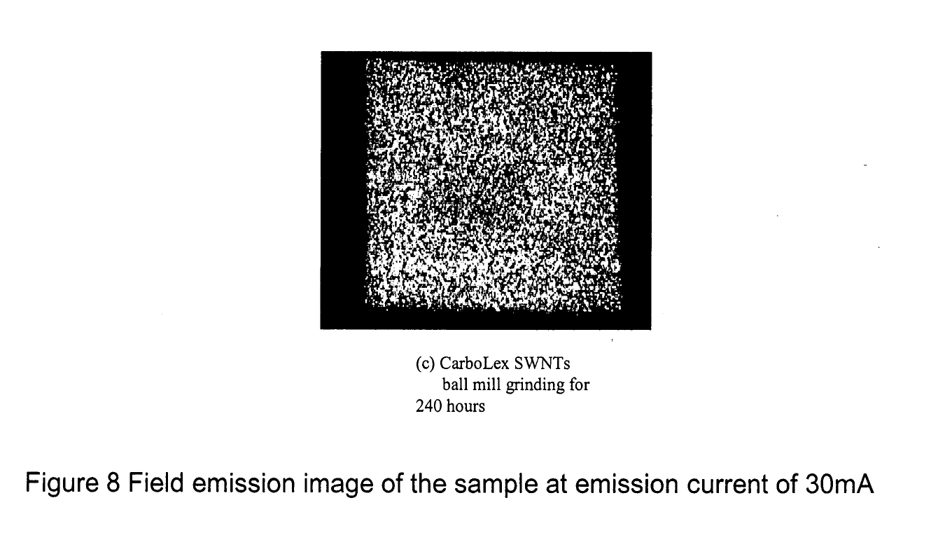

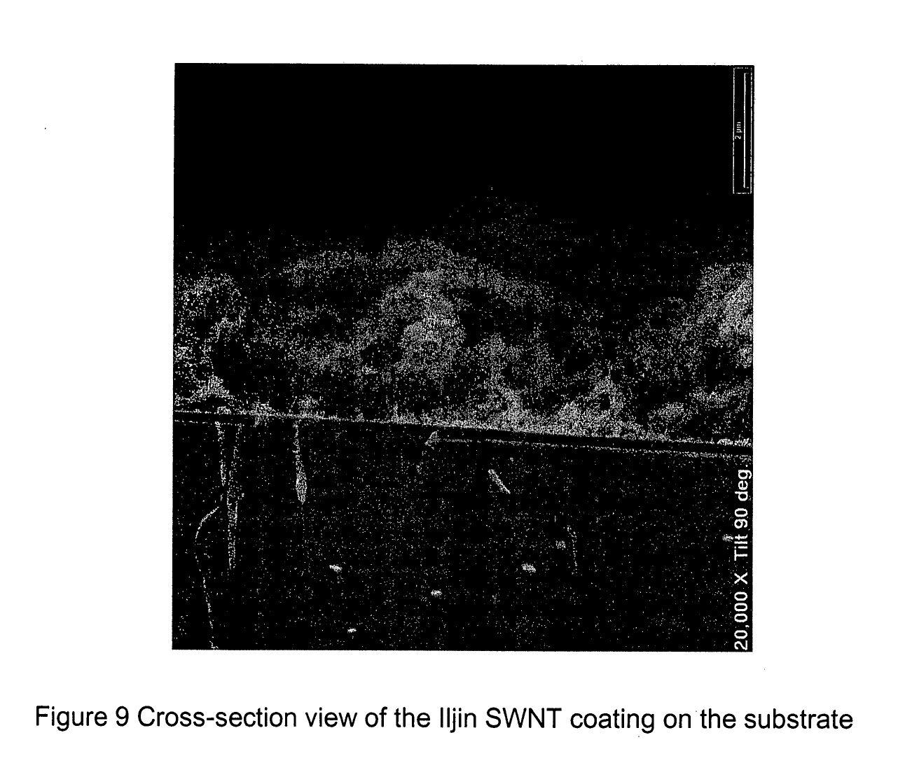

Its field emission properties were tested after the activation process. FIG. 8 shows a field emission image of this sample at emission current of 30 mA. It can be seen that excellent field emission uniformity was obtained. A cross-section SEM image was taken and it could be seen that the thickness of the CNT coating was around 2 microns (See FIG. 9). The CNTs were vertically aligned CNTs and separated with each other. It means that the grinding process can very effectively disperse and shorten the CNT clusters and ropes. So the distribution of the diameter and length of the CNTs can be further narrowed.

As a result, an object of the present invention is to prepare a carbon nanotube layer for a field emission cathode wherein individual carbon nanotubes or small groups of carbon nanotubes that stick out from the surface more than the rest of the layer are avoided. Electron fields will concentrate on these sharp points, creating an enhanced image on the phosphor, resulting in a more luminous spot than the surroundings. Activation processes actually further free such carbon nanotubes or groups of carbon nanotubes sticking out from the surface, exasperating the problem.

What is claimed is:

1. A carbon nanotube (CNT) cathode comprising CNTs with a variation of lengths less than 20% for 90% of a total quantity of the CNTs.

2. The cathode of claim 1, wherein a flatness variation of a CNT coating using the CNTs is less than 20% before or after an activation step.

3. The cathode of claim 1, wherein the carbon nanotubes are selected from the group of single-wall carbon nanotubes, double-wall carbon nanotubes, multi-wall carbon nanotubes, buckytubes, carbon fibrils, chemically-modified carbon nanotubes, derivatized carbon nanotubes, metallic carbon nanotubes, semiconducting carbon nanotubes, metallized carbon nanotubes, and combinations thereof.

4. The cathode of claim 1, wherein the carbon nanotubes are mixed with particles selected from the group consisting of spherical particles, dish-shaped particles, lamellar particles, rod-like particles, metal particles, semiconductor particles, polymeric particles, ceramic particles, dielectric particles, clay particles, fibers, nanparticles, and combinations thereof.

5. The cathode of claim 1, wherein the average length of CNTs is less than 5 microns.

6. The cathode of claim 5, wherein a layer of cathode material comprising the CNTs has a thickness which ranges from about 10 nm to about 20 micron.

7. A field emission display device comprising: a) an anode assembly; and b) a cathode assembly, wherein the cathode assembly comprises:
a substrate;
an electrically conducting layer deposited on the substrate;
a field emission cathode material deposited as a layer over the electrically conducting layer; and
a CNT layer utilizing the CNTs with a variation of lengths less than 20% for 90% of the total quantity of CNTs.

8. The display of claim 7, wherein the CNT layer is deposited by spray, screen-printing spin-coating, dispersing, ink-jet printing, electrophoresis deposition, brushing, dipping, dry coating, or other methods.
